(19) United States
(12) Patent Application Publication
(10) Pub. No.: US 2013/0008081 A1
(43) Pub. Date: Jan. 10, 2013

(54) METHODS AND SYSTEMS FOR MAKING LIQUID FUEL FROM CELLULOSE IN THERMAL REACTORS

(75) Inventor: Samuel C. Weaver, Knoxville, TN (US)

(73) Assignee: Proton Power, Inc., Knoxville, TN (US)

(21) Appl. No.: 12/827,647

(22) Filed: Jun. 30, 2010

Related U.S. Application Data
(60) Provisional application No. 61/221,750, filed on Jun. 30, 2009.

(51) Int. Cl. C10L 1/182; B01J 19/00

(52) U.S. Cl. 44/451; 422/198

(57) ABSTRACT

Methods and systems are disclosed for making a liquid fuel from a compound having carbon, oxygen, and hydrogen, such cellulosic biomass, which includes cellulose, lignin, hemicellulose, and combinations thereof. The compound is combined with water to produce a wet form of the compound, which is transferred into a reaction processing chamber. The wet form of the compound is heated within the reaction chamber such that elements of the wet form of the compound dissociate and react. One reaction product is the liquid fuel.

### CROSS-REFERENCES TO RELATED APPLICATIONS

This application is a non-provisional patent application claiming priority benefit of U.S. provisional patent application Ser. No. 61/221,750, filed on Jun. 30, 2009 and entitled “METHODS AND SYSTEMS FOR MAKING LIQUID FUEL FROM CELLULOSE IN THERMAL REACTORS,” the entire disclosure of which is herein incorporated by reference for all purposes.

This application is related to U.S. Pat. Appl. No. 12/033,740, entitled “CONVERSION OF CELLULOSE INTO HYDROGEN FOR POWER GENERATION,” filed Feb. 19, 2008 by Samuel C. Weaver et al., and to U.S. Pat. Appl. No. 12/430,616, entitled “Conversion of C—O—H Compounds Into Hydrogen for Power or Heat Generation,” the entire disclosure of each of which is incorporated herein by reference for all purposes.

### BACKGROUND

This application relates generally to the production of liquid fuel. More specifically, this application relates to the production of liquid fuel from cellulosic biomass in a thermal reactor.

Extensive work has been done on conversion of cellulose, which is one example of a C—O—H compound, into ethanol (molecular formula: C₂H₅OH). Ethanol is known as drinking alcohol found in beverages. Ethanol is a flammable solvent and miscible with water and many organic solvents. The largest use of ethanol is as a motor fuel and fuel additive. In the United States, ethanol is most commonly blended with gasoline as a 10% ethanol blend. This blend is widely sold throughout the U.S. Midwest, and in cities required by the 1990 Clean Air Act to oxygenate their gasoline during wintertime. The energy returned on energy invested for ethanol made from corn in the U.S. is 1.34. This means that it yields 34% more energy than it takes to produce it.

While various techniques thus exist in the art for making liquid fuel from C—O—H compounds, there is still a general need for the development of alternative techniques. This need is driven at least in part by the wide variety of applications that make use of liquid fuels, some of which have significantly different operation considerations than others.

### BRIEF SUMMARY

Embodiments provide methods and systems for making a liquid fuel from a compound that comprises carbon, oxygen, and hydrogen. Water is combined with the compound to produce a wet form of the compound, which is transferred into a reaction processing chamber. The wet form of the compound is heated within the reaction chamber such that elements comprised by the wet form of the compound dissociate and react, with one reaction product comprising the liquid fuel.

In some embodiments, systems are provided that may comprise a processing chamber, a heating source, a source of the compound and a source of water, a subsystem for controlling the heating source, and an exhaust system. The heating source is provided in thermal communication with an interior of the processing chamber. The source of the compound is disposed within the processing chamber. The source of water is to wet the source of the compound. The subsystem for controlling the heating source is to induce a dissociation and reaction of the wet source of the compound, with one reaction product comprising the liquid fuel. The exhaust system is for extraction of resulting gases from the processing chamber.

A variety of different reactions may be induced in different embodiments to make different liquid fuels. In some embodiments, the compound comprising carbon, oxygen, and hydrogen comprises cellulose. In some embodiments, the compound comprising carbon, oxygen, and hydrogen comprises lignin. In some embodiments, the compound comprising carbon, oxygen, and hydrogen comprises hemicellulose. The liquid fuel may comprise methanol, ethanol, propanol, butanol, gasoline, or diesel in different embodiments.

Additional embodiments and features are set forth in part in the description that follows, and in part will become apparent to those skilled in the art upon examination of the specification or may be learned by the practice of the invention. A further understanding of the nature and advantages of the embodiments may be realized by reference to the remaining portions of the specification and drawings.

### BRIEF DESCRIPTION OF THE DRAWINGS

FIG. 1A is a schematic diagram of a simplified system for making liquid fuels from C—O—H compounds such as cellulose, lignin, and/or hemicellulose.

FIG. 1B is a schematic diagram of a simplified system for hydrogen to be burned in a combustion chamber.

FIG. 1C is a schematic diagram of a simplified system for conversion of hydrogen gas into electrical power by a fuel cell.

FIG. 2 is a flow diagram that summarizes general aspects of methods for making liquid fuels from C—O—H compounds such as cellulose, lignin, and/or hemicellulose.

### DETAILED DESCRIPTION

Embodiments provide methods and systems for making liquid fuel from compounds that comprise carbon, oxygen, and hydrogen. The liquid fuel is collected, but in some embodiments a byproduct of the methods and systems includes the production of molecular hydrogen, which may also be collected and used in energy production.

Merely for purposes of illustration, certain specific reactions involving cellulose are described herein as examples of how the methods and processes disclosed may be implemented. The techniques may, however, be readily applicable more generally to C—O—H compounds and illustrations using cellulose are not intended in any way to limit the scope of the invention. For example, the techniques may be readily applicable to C—O—H compounds such as cellulosic biomass, also referred to as lignocellulose, including hemicellulose and lignin, along with cellulose, and combinations thereof.

Examples of the reactions that may be used in embodiments where the C—O—H compound comprises cellulose include, but are not limited to, the following.

Production of Methanol

C₆H₁₀O₅+6H₂O→CH₄O+5CO₂+9H₂

C₆H₁₀O₅+5H₂O→2CH₄O+4CO₂+6H₂

C₆H₁₀O₅+4H₂O→3CH₄O +3CO₂+3H₂

C₆H₁₀O₅+3H₂O→4CH₄O +2CO₂

Production of Ethanol

C₆H₁₀O₅+4H₂O→C₂H₆O+4CO₂+6H₂

C₆H₁₀O₅+H₂O→2C₂H₆O+2CO₂

Production of Propanol

C₆H₁₀O₅+2H₂O→C₃H₈O+3CO₂+3H₂

Production of Butanol

C₆H₁₀O₅→C₄H₁₀O+2CO₂

Production of Gasoline

C₆H₁₀O₅+4C+4H₂O→C₇H₁₆+2CO₂

Production of Diesel

C₆H₁₀O₅+10C+2H₂O→C₁₆H₂₄+6CO₂

In most instances, the above reactions make use of water in addition to cellulose and may proceed by providing a wet form of the cellulose. In other instances, a source of carbon is provided with the cellulose as one of the reactants.

Systems for Making Liquid Fuels from C—O—H Compounds

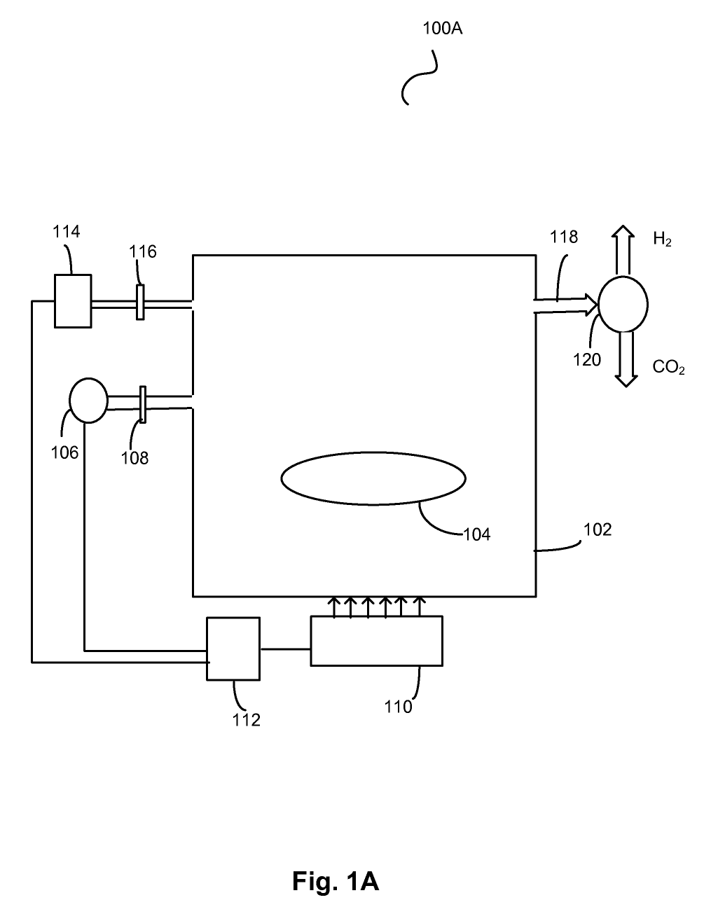

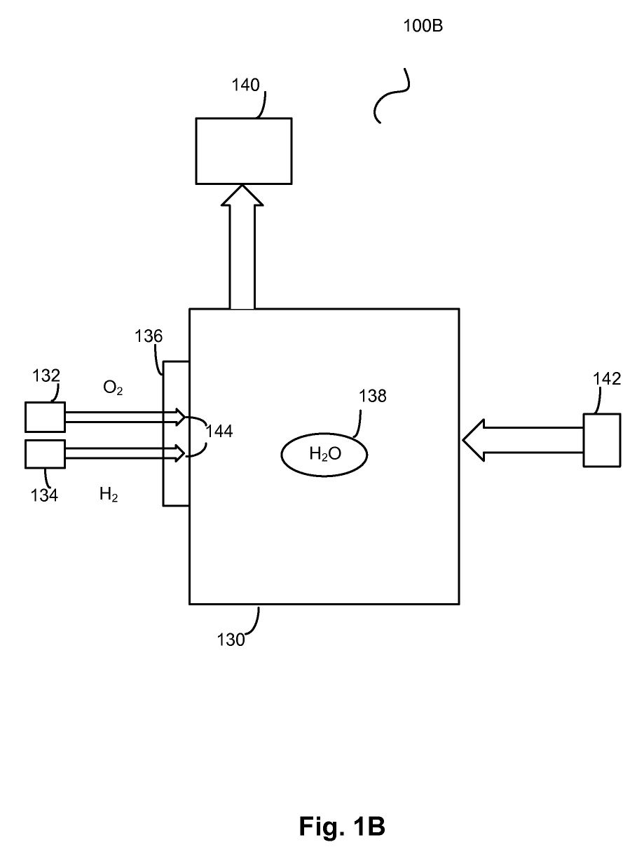

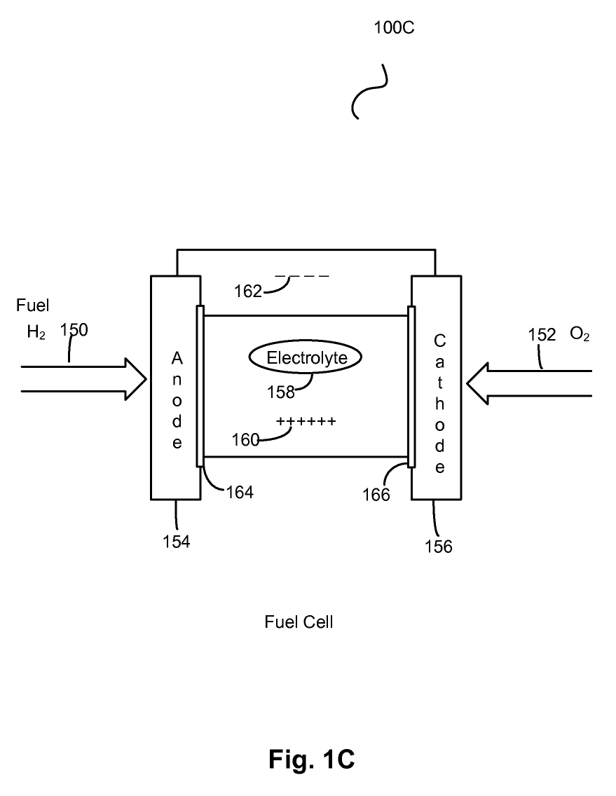

A general overview of a simplified system 100A for making a liquid fuel from a C—O—H compound is provided with FIG. 1A. The system 100A comprises a chamber 102, a heating system 110 in a thermal communication with the chamber 102, a gas supply line 114 for providing inert gas into the chamber 102, a water supply line 106 for water to be added to the chamber 102, an exhaust line 118 to allow the product gases (such as H₂ and CO₂, depending on the specific reaction(s) used) to exit the chamber 102 to flow into a gas separator 120, and a controller 112. The cellulose or other C—O—H compound 104, such as hemicellulose or lignin, or combinations thereof, is disposed within the chamber 102. Some processes may use an inert gas, although this is not required by all embodiments, and the controller 112 controls when to flush the chamber 102 with inert gas by using a valve 116. The controller 112 also may control the heating system 110 to provide the elevated temperatures that the chamber needs to cause the cellulose or other C—O—H compound 104 to be dissociated in the environment within the chamber 102. The controller 112 may also control when water is added into the chamber 102 and the amount of water needed for reacting the cellulose or other C—O—H compound 104 and water. The controller 112 may further control the temperature of the heating system 110 to provide water vapor and to heat the cellulose or other C—O—H compound 104 to cause the chemical reaction of the cellulose or other C—O—H compound 104 with water. The gas separator 120 is to separate the gaseous products of the reaction (e.g., H₂ and CO₂ gases and perhaps other reaction products) after the gases (H₂, CO₂) exit the chamber 102. The reaction product liquid fuel is then available for collection. In some embodiments, the hydrogen and/or carbon dioxide gases may be extracted as end products.

In some specific embodiments that produce hydrogen gas as an end product, the hydrogen gas can then be further used to generate electrical power or heat by different systems. In one embodiment, the gas supply line 114 for providing inert gas is not present. In such a case, air inside the chamber 102 may react with the cellulose or other C—O—H compound 104 to produce the liquid fuel until the air is depleted.

Techniques for hydrogen burning to generate power and/or heat are known in the art. The entire contents of a U.S. patent application Ser. No.: 7,144,826 B2, entitled “Method and Apparatus for the Production of Process Gas That includes Water Vapor and Hydrogen Formed by Burning Oxygen in a Hydrogen-Rich Environment” by George Roters, Helmut Sommer, Genrih Erlikh, and Yehuda Pashut, are incorporated herein by reference for all purposes.

For illustration purposes, a simplified exemplary system 100B for hydrogen burn is provided in FIG. 1B. The system 100B comprises a combustion chamber 130, a burner 136 for igniting hydrogen burning in oxygen to form water vapor 138 and generate heat, a H₂ gas supply line for providing H₂ into the combustion chamber 130, a gas supply line for providing O₂ into the combustion chamber 130, an exhaust line 140 for water vapor steam 138 to exit the combustion chamber 130, and an inert gas supply line 142 for providing inert gas to flush the combustion chamber prior to introducing H₂ gas to the combustion chamber 130 in embodiments where such inert gas is used. The ratio of hydrogen gas 132 and oxygen gas 134 may be provide such that hydrogen may be thoroughly burned in oxygen. The water vapor 138 may be converted into electrical power in the converter 140 by any of several techniques known in the art. In general, instead of oxygen, an oxygen-containing gas, such as, among others, NO or O₃, can be used. As noted, in specific embodiments, the gas supply line 142 for providing inert gas is not present. In such a case, air inside the chamber 130 may react with the cellulose or other C—O—H compound, such as hemicellulose or lignin, or combinations thereof, to produce water and carbon dioxide until the air is depleted.

After the combustion chamber is filled with hydrogen 132, the heating system 136 may be activated and now oxygen 134 may be introduced into the chamber. In the combustion chamber 130, the oxygen 134 may be introduced, for example, with a time delay of five seconds relative to hydrogen 132. The heating system 136 may heat the region near the outlet 144 to about 700° C. to ignite the combustion. The ratio of the oxygen 134 to the hydrogen 132 may be provided into the combustion chamber so that the hydrogen is completely burned.

Another method of conversion of hydrogen into electrical power is using a fuel cell. A fuel cell is an electrochemical energy conversion device. It transforms chemical power into electrical power. A fuel cell can convert hydrogen and oxygen into water and produce electricity and heat. A fuel cell can also use other fuel sources than hydrogen gas, such as liquid fuel like methanol, natural gas, gasoline, and the like. A fuel cell power generation equipment may comprise an anode, an electrolyte membrane, a cathode and a diffusion layer, wherein fuel is oxidized at an anode and oxygen is reduced at a cathode, such as described in U.S. patent application Ser. No: 7,192,666 B2, entitled “Apparatus and Method for Heating Fuel Cells” by John C. Calhoon, the entire contents of which are incorporated herein by reference for all purposes.

FIG. 1C shows a simplified fuel cell system 100C for using H₂ gas as fuel. The system 100C comprises an anode 154, and a cathode 156, an electrolyte 158, a hydrogen gas 150 supply line, and an oxygen gas 152 supply line. Hydrogen 150 from the gas supply line may be fed to the anode 154 of the fuel cell, while oxygen 152 from the gas supply line may be fed to the cathode 156 of the fuel cell. The hydrogen 100 atoms reacting with a catalyst 164 in the anode 154, are split into protons 160 and electrons 162. Meanwhile, an oxygen molecule 152 reacting with a catalyst 166 in the cathode 156, is split into two separate oxygen atoms bearing negative charges.

The electrolyte 158 may be positioned between the anode 154 and the cathode 156. The electrolyte 158 may function as a conductor for carrying protons 160 between the anode 154 and the cathode 156. In some cases, the protons 160 are permitted to pass through the electrolyte while the electrons 162 are not. The protons 160 pass through the electrolyte 158 towards the oxygen 152 in the cathode 156. The result is a build up of negative charge in the anode 154 due to that the electrons 162 are left behind. The electrical potential generated by the buildup of electrons 162 is used to supply electrical power. Meanwhile, the protons diffuse through the membrane (electrolyte) to the cathode, where a hydrogen atom is recombined at the cathode and reacted with oxygen to form water at the cathode.

There are many types of fuel cells for converting hydrogen and oxygen into water and generating electricity, for instance, among others, phosphoric acid fuel cell (PAFC), Proton Exchange Membrane (PEM), Molten Carnoate Fuel Cell (MCFC), Solid Oxide Fuel Cell (SOFC), and Alkaline Fuel Cell (AFC). The efficiencies may vary from various fuel cells. For example, efficiencies may range from 30% to 85%.

The chemical reactions also vary from fuel cells. For example, the chemical equations for describing the PEM reactions in the anode, cathode, and the fuel cell are provided as follows:

Anode: H₂(g)→2H⁺(aq)+2e⁻

Cathode: ½O₂(g)+2H⁺(aq)+2e⁻→H₂O (1)

Fuel Cell: H₂(g)+½O₂(g)→H₂O (1)

Another example of the chemical reactions for describing the PAFC reactions is provided below:

Anode: H₂(g)→2H⁺(aq)+2e⁻

Cathode: ½O₂(g)+2H⁺(aq)+2e⁻→H₂O (1)

Fuel Cell: H₂(g)+½O₂(g)+CO₂→H₂O (1)+CO₂

Note that PAFCs can tolerate a low concentration of CO₂ of about 1.5%, which may allow a broad selection of acceptable hydrogen fuels.

Processes for Making Liquid Fuel from Cellulose or Other C—O—H Compounds

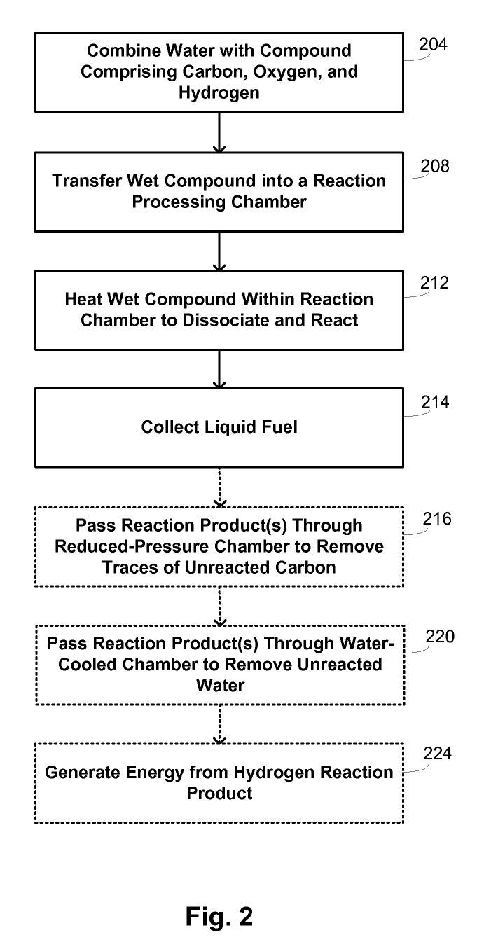

FIG. 2 provides an overview of methods that may be used for making liquid fuel from the cellulose or other C—O—H compounds, such as lignin or hemicellulose, or combinations thereof. In FIG. 2, the specific selection of steps shown and the order in which they are shown is intended merely to be illustrative. It is possible for certain steps to be performed in alternative orders, for certain steps to be omitted, and for certain additional steps to be added according to different embodiments of the invention. Some but not all of these variants are noted in the description that follows.

At block 204 of FIG. 2, water is combined with the cellulose or other C—O—H compound such as hemicellulose or lignin, or combinations thereof. The wet compound is transferred into a reaction processing chamber at block 208. These two steps provide one example of steps whose order may be changed in alternative embodiments. For example, the compound may be disposed in the reaction processing chamber in a dry state, with the “transfer” effected by combining it with water while disposed there. In still other instances, water may be applied to the compound as it is moved into the reaction processing chamber, such as by using a spray system, as part of the transfer.

At block 212, the wet compound is heated within the reaction chamber. Such heating may be accomplished using a variety of different techniques known to those of skill in the art, some of which have been described above for specific structural embodiments. In some instances, the compound is heated to a temperature between 700° C. and 1100° C. although other temperatures are known by the inventors also to be effective. Heating the wet compound causes dissociation and reaction of the dissociated elements, with typical reaction products including molecular hydrogen H₂ and carbon dioxide CO₂ in addition to the liquid fuel. The specific reaction products depend on the reaction mechanisms used, examples of which were provided above. The liquid fuel is collected at block 214.

In those embodiments in which molecular hydrogen that is produced within the reaction chamber is further processed, those steps indicated at blocks 216-224 may be performed, although these steps are not included in every embodiment. They are accordingly indicated with broken lines.

In particular, it is not expected that the production of liquid fuel will be 100% and there may be traces of unreacted elements remaining in the reaction products. For example, passing the liquid-fuel reaction product through a reduced-pressure chamber at block 216 may be useful in removing traces of unreacted carbon and passing the liquid-fuel reaction product through a water-cooled chamber at block 220 may be useful in removing unreacted water.

Once the hydrogen has been extracted as an end product from the process, it may be processed at block 224 to generate energy, such as by using a burning process or a fuel-cell process as described above. In some embodiments, the carbon dioxide gas may also be extracted as an end product.

### OTHER POTENTIAL APPLICATIONS

The process for making liquid fuel from cellulose or other C—O—H compounds, such as hemicellulose or lignin, or combinations thereof, may enhance the recycling of cellulosic biomass products and turn cellulosic waste into liquid fuel and to be used for energy production. For instance, the waste of cellulosic biomass includes forest floors that currently may not be economical to recover, but present a serious fire hazard. Recycling this cellulosic waste through the use of different embodiments may reduce this hazard problem. Other cellulosic waste that currently ends up in the land fills may also be utilized through recycling.

What is claimed is:

1. A method for making a liquid fuel from a compound comprising carbon, oxygen, and hydrogen, the method comprising:
combining water with the compound to produce a wet form of the compound;
transferring the wet form of the compound into a reaction processing chamber;
heating the wet form of the compound within the reaction chamber such that elements comprised by the wet form of the compound dissociate and react, wherein one reaction product comprises the liquid fuel.

2. The method recited in claim 1 wherein the compound comprising carbon, oxygen, and hydrogen comprises cellulose.

3. The method recited in claim 1 wherein the compound comprising carbon, oxygen, and hydrogen comprises lignin.

4. The method recited in claim 1 wherein the compound comprising carbon, oxygen, and hydrogen comprises hemicellulose.

5. The method recited in claim 2 wherein:
the liquid fuel comprises methanol; and
heating the wet form of the compound within the reaction chamber comprises inducing the reaction C₆H₁₀O₅+6H₂O→CH₄O+5CO₂+9H₂.

6. The method recited in claim 2 wherein:
the liquid fuel comprises methanol; and
heating the wet form of the compound within the reaction chamber comprises inducing the reaction C₆H₁₀O₅+5H₂O→2CH₄O+4CO₂+6H₂.

7. The method recited in claim 2 wherein:
the liquid fuel comprises methanol; and
heating the wet form of the compound within the reaction chamber comprises inducing the reaction C₆H₁₀O₅+4H₂O→3CH₄O+3CO₂+3H₂.

8. The method recited in claim 2 wherein:
the liquid fuel comprises methanol; and
heating the wet form of the compound within the reaction chamber comprises inducing the reaction C₆H₁₀O₅+3H₂O→4CH₄O+2CO₂.

9. The method recited in claim 2 wherein:
the liquid fuel comprises ethanol; and
heating the wet form of the compound within the reaction chamber comprises inducing the reaction C₆H₁₀O₅+4H₂O→C₂H₆O+4CO₂+6H₂.

10. The method recited in claim 2 wherein:
the liquid fuel comprises ethanol; and
heating the wet form of the compound within the reaction chamber comprises inducing the reaction C₆H₁₀O₅+H₂O→2C₂H₆O+2CO₂.

11. The method recited in claim 2 wherein:
the liquid fuel comprises propanol; and
heating the wet form of the compound within the reaction chamber comprises inducing the reaction C₆H₁₀O₅+2H₂O→C₃H₈O+3CO₂+3H₂.

12. The method recited in claim 2 wherein:
the liquid fuel comprises butanol; and
heating the wet form of the compound within the reaction chamber comprises inducing the reaction C₆H₁₀O₅→C₄H₁₀O+2CO₂.

13. The method recited in claim 2 wherein:
the liquid fuel comprises gasoline; and
heating the wet form of the compound within the reaction chamber comprises inducing the reaction C₆H₁₀O₅+4C+4H₂O→C₇H₁₆+2CO₂.

14. The method recited in claim 2 wherein:
the liquid fuel comprises diesel; and
heating the wet form of the compound within the reaction chamber comprises inducing the reaction C₆H₁₀O₅+10C+2H₂O→C₁₆H₂₄+6CO₂.

15. The method recited in claim 1, further comprising:
extracting a hydrogen gas that is another reaction product as an end product.

16. The method recited in claim 1, further comprising:
extracting a carbon dioxide gas that is another reaction product as an end product.

17. A system for making a liquid fuel from a compound comprising carbon, oxygen, and hydrogen, the system comprising:
a processing chamber;
a heating source in thermal communication with an interior of the processing chamber;
a source of the compound disposed within the processing chamber;
a source of water to wet the source of the compound;
a subsystem for controlling the heating source to induce a dissociation and reaction of the wet source of the compound, wherein one reaction product comprises the liquid fuel; and
an exhaust system for extracting resulting gases from the processing chamber.

18. The system recited in claim 17 wherein the compound comprising carbon, oxygen, and hydrogen comprises cellulose.

19. The system recited in claim 17 wherein the compound comprising carbon, oxygen, and hydrogen comprises lignin.

20. The system recited in claim 17 wherein the compound comprising carbon, oxygen, and hydrogen comprises hemicellulose.

21. The system recited in claim 18 wherein:
the liquid fuel comprises methanol; and
heating the wet form of the compound within the reaction chamber comprises inducing the reaction C₆H₁₀O₅+6H₂O→CH₄O+5CO₂+9H₂.

22. The system recited in claim 18 wherein:
the liquid fuel comprises methanol; and
heating the wet form of the compound within the reaction chamber comprises inducing the reaction C₆H₁₀O₅+5H₂O→2CH₄O+4CO₂+6H₂.

23. The system recited in claim 18 wherein:
the liquid fuel comprises methanol; and
heating the wet form of the compound within the reaction chamber comprises inducing the reaction C₆H₁₀O₅+4H₂O→3CH₄O+3CO₂+3H₂.

24. The system recited in claim 18 wherein:
the liquid fuel comprises methanol; and
heating the wet form of the compound within the reaction chamber comprises inducing the reaction C₆H₁₀O₅+3H₂O→4CH₄O+2CO₂.

25. The system recited in claim 18 wherein:
the liquid fuel comprises ethanol; and
heating the wet form of the compound within the reaction chamber comprises inducing the reaction C₆H₁₀O₅+4H₂O→C₂H₆O+4CO₂+6H₂.

26. The system recited in claim 18 wherein:
the liquid fuel comprises ethanol; and
heating the wet form of the compound within the reaction chamber comprises inducing the reaction C₆H₁₀O₅+H₂O→2C₂H₆O+2CO₂.

27. The system recited in claim 18 wherein:
the liquid fuel comprises propanol; and
heating the wet form of the compound within the reaction chamber comprises inducing the reaction C₆H₁₀O₅+2H₂O→C₃H₈O+3CO₂+3H₂.

28. The system recited in claim 18 wherein:
the liquid fuel comprises butanol; and
heating the wet form of the compound within the reaction chamber comprises inducing the reaction C₆H₁₀O₅→C₄H₁₀O+2CO₂.

29. The system recited in claim 17 wherein:
the liquid fuel comprises gasoline; and
heating the wet form of the compound within the reaction chamber comprises inducing the reaction C₆H₁₀O₅+4C+4H₂O→C₇H₁₆+2CO₂.

30. The system recited in claim 18 wherein:
the liquid fuel comprises diesel; and
heating the wet form of the compound within the reaction chamber comprises inducing the reaction C₆H₁₀O₅+10C+2H₂O→C₁₆H₂₄+6CO₂.

31. The system recited in claim 17 wherein one resulting gas comprises a hydrogen gas as an end product.

32. The system recited in claim 17 wherein one resulting gas comprises a carbon dioxide gas as an end product.
